(19) United States
(12) Patent Application Publication
(10) Pub. No.: US 2023/0385851 A1
(43) Pub. Date: Nov. 30, 2023

(54) TOOLS AND METHODS FOR USER-ENGAGEMENT MODELING AND OPTIMIZATION

(71) Applicant: Microsoft Technology Licensing, LLC, Redmond, WA (US)

(72) Inventors: Ruby MAZUMDAR, Redmond, WA (US); Andrey Zaikin, Redmond, WA (US)

(21) Appl. No.: 17/827,936

(22) Filed: May 30, 2022

(51) Int. Cl. G06Q 30/02; G06N 20/00

(52) U.S. Cl. CPC G06Q 30/0201; G06N 20/00

(57) ABSTRACT

Methods, systems, and computer programs are presented for automated hypothesis generation and evaluation. One method includes an operation for generating a user interface (UI) for identifying a baseline segment and a target segment of users of a product or service. The UI further provides at least one option for configuring parameters for generating a hypothesis. The method further includes an operation for generating the hypothesis based on the configured parameters. The hypothesis defines a campaign to reach members of the baseline segment in order to transfer members from the baseline segment to the target segment. The method further includes estimating, by a machine-learning model, at least one performance metric value that would result from implementing the hypothesis to transfer members from the baseline segment to the target segment. Further, the method includes an operation for causing presentation on the UI of the hypothesis and the at least one performance metric.

### TECHNICAL FIELD

The subject matter disclosed herein generally relates to methods, systems, and machine-readable storage media for automatically selecting and evaluating hypotheses for process improvement.

### BACKGROUND

In complex systems, it is often difficult to determine how to improve the system given the large number of variables involved. One method for improvement is to introduce a change, referred to herein as an hypothesis to be validated, and then observe if the system improves.

Product teams often struggle in producing data-driven hypotheses which will result in improvement of business metrics, and companies end up wasting valuable time and resources in experimenting with so-called “guess” ideas which might not lead to true improvement. In addition, running a wrong hypothesis will result in time, resource, and labor costs that do not bring any insights or improvements for product growth.

There could be many possible parameters to alter for a hypothesis, and when considering combinations of parameters to alter, the number of combinations will grow exponentially with the number of parameters considered. Thus, selecting the right combination of parameters for process improvement can be a daunting task for a system manager. Also, testing many possible combinations is usually expensive due to the consumption of resources to test each hypothesis.

### BRIEF DESCRIPTION OF THE DRAWINGS

Various of the appended drawings merely illustrate example embodiments of the present disclosure and cannot be considered as limiting its scope.

FIG. 1 is a sample environment for implementing embodiments.

FIG. 2 illustrates the hypothesis generation and validation process, according to some example embodiments.

FIG. 3 is a high-level process description for hypothesis generation and impact estimation, according to some example embodiments.

FIG. 4 illustrates the data management for the analytical framework to evaluate hypotheses, according to some example embodiments.

FIG. 5 illustrates the evaluation loop for ongoing scenario evaluation and improvement, according to some example embodiments.

FIG. 6 is a sample user interface (UI) for the hypothesis factory tool, according to some example embodiments.

FIG. 7 is a sample UI for the configuration and analysis of hypotheses, according to some example embodiments.

FIG. 8 illustrates the joining of scenarios for determining the greatest impact of conversion, according to some example embodiments.

FIG. 9 is a flowchart of a method for hypothesis feedback and evaluation, according to some example embodiments.

FIG. 10 is a flowchart of a method for the hypothesis feedback collector, according to some example embodiments.

FIG. 11 illustrates an example clustering of users, according to some example embodiments.

FIG. 12 illustrates a sample evaluation of stages for evaluation by the evaluation model, according to some example embodiments.

FIG. 13 illustrates the training and use of a machine-learning model, according to some example embodiments.

FIG. 14 is a flowchart of a method for hypothesis generation and evaluation, according to some example embodiments.

FIG. 15 is a block diagram illustrating an example of a machine upon or by which one or more example process embodiments described herein may be implemented or controlled.

### DETAILED DESCRIPTION

Example methods, systems, and computer programs are directed to automated hypothesis generation and evaluation. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

Product-growth teams expand the value of products through rapid, data-informed experimentation. In some cases, the growth process utilizes a scientific method that creates hypotheses to test process improvements, prioritize the hypothesis for experimentation, run the experiments, and determine if each tested hypothesis generates an improvement. The process may then be repeated with new hypothesis and validation cycles.

In one aspect, functional usage data for a set of users of an application is used to identify user segments of interest that may result in improvements if users of a product or service are migrated from one segment to another. Based on differences of a selected metric value between these segments, a hypothesis is generated for trying to migrate users from a baseline segment to a target segment.

Hypothesis tools offer experimenters a set of configurable parameters (e.g., campaign reach, interaction rate, effectiveness) to estimate a lift in the desired metric value. The analytical framework automates the process of visualizing the user base and corresponding behavior within the application to identify the best actionable hypotheses for experimentation.

The tools provide options for setting parameters (e.g., tuning knobs) based on a campaign vehicle used to implement these hypotheses. The tool also provides a hypothesis selection engine to identify the most impactful hypothesis (based on a variety of different scenario combinations) in terms of performance improvement (e.g., increment retained users, retention lift).

The application manager can create multiple hypothesis using the hypothesis tools and obtain estimates on the expected impact on the performance metric. For example, the manager can select target segments and target behaviors, with the corresponding parameters (e.g., campaign reach, interaction, and effectiveness) to identify realistic estimates for the expected impact of the hypotheses. Further, feedback from previous experiments is incorporated to continuously improve the hypothesis estimation process.

In one aspect, embodiments relate to data visualization and a method for automating hypothesis generation and calculation of impact of each hypothesis on business metrics. The process explores and identifies potential hypothesis candidates for experimentation based on the observation data of user behavior. One aspect includes an analytical framework including a data ingestion layer, a data processing layer, and a data visualization layer to provide an end-end hypothesis generation solution. Gathering feedback signals from historical data helps in the hypothesis evaluation of success or failure, impact estimation on the target variable, and generating more combinations for new hypotheses.

Automating hypothesis generation helps scale and speed up the evaluation of hypotheses, saving time for the analysis team and helping product managers to create multiple hypothesis and measure the estimated impact on the product. A hypothesis tool provides options for the product manager to select target segments and target behaviors for desired driven change, tune parameters (e.g., campaign reach) for a campaign (e.g., experiment), and calculate estimates for the impact of the hypothesis.

One general aspect includes a method that includes an operation for generating a user interface (UI) for identifying a baseline segment and a target segment of users of a product or service. The UI further provides at least one option for configuring parameters for generating a hypothesis. The method further includes an operation for generating the hypothesis based on the configured parameters. The hypothesis defines a campaign to reach members of the baseline segment in order to transfer members from the baseline segment to the target segment. The method further includes estimating, by a machine-learning (ML) model, at least one performance metric value that would result from implementing the hypothesis to transfer members from the baseline segment to the target segment. Further, the method includes an operation for causing presentation on the UI of the hypothesis and the at least one performance metric.

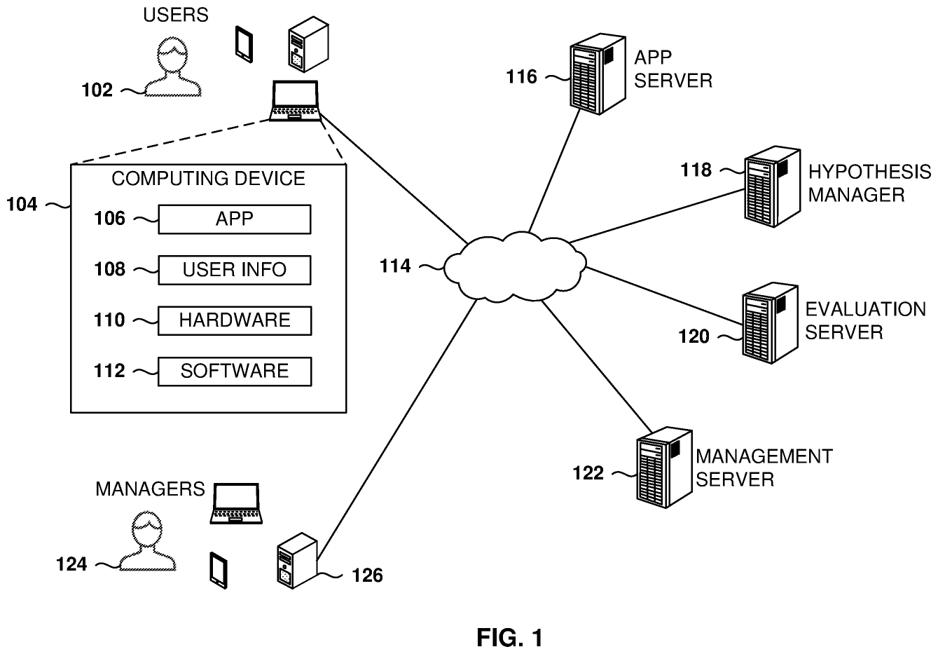

FIG. 1 is a sample environment for implementing embodiments. Users 102 utilize computing devices 104 (e.g., phone, laptop, PC, tablet) to use a software application (also referred to herein as app 106), which may be executed on the computing device 104, or executed on a remote server (e.g., app server 116) with the computing device providing a user interface. The computing device 104 may use a network 114, such as the Internet, to access multiple devices.

In some example embodiments, the computing device 104 includes, among other modules, the app 106, user information 108 (e.g., username, login name, user address, user phone number), a certain hardware 110, and other software 112. In some cases, the app 106 may not be included in the computing device 104 as the app is executed remotely on the app server 116, and a web browser may be used to access a user interface provided by the app server 116.

Further, a management server 122 provides tools for the generation and testing of hypotheses to improve a product. As used herein, a hypothesis is a proposition for making a change to one or more parameters of a system in order to improve one or more system performance metrics.

Some of the embodiments are described with reference to improving the performance of the app 106, but the same principles may be utilized for the improvement of other products or services. The management server 122 provides a user interface available to managers 124, using computing device 126, for the management of hypotheses. Further, a hypothesis manager 118 manages the generation of hypothesis, and an evaluation server 120 manages the testing and evaluation of the hypotheses.

It is noted that the embodiments illustrated in FIG. 1 are examples and do not describe every possible embodiment. Other embodiments may utilize different servers, combine the functionality of one or more servers into one, divide the functionality of one server into multiple servers in a distributed fashion, etc. The embodiments illustrated in FIG. 1 should therefore not be interpreted to be exclusive or limiting, but rather illustrative.

In some example embodiments, a goal of the hypothesis tools is to help a manager to improve retention of the users 102 utilizing the app 106. Retention may be defined by the manager, but in some cases, retention means having people to continue using the app for at least a predetermined time period. In other cases, retention means having people renew a subscription to the app 106. For example, if a user is using the Microsoft™ PowerPoint™ application, the manager wants to make sure that users continue using the app, that is, make sure that the users do not stop using the app because it may cause the user to stop the subscription when time to renew comes up.

To improve retention, the manager 124 analyzes the different ways in which a user utilizes the application. For example, for the PowerPoint case, one user may simply read presentations create by others, other users are actively engaged in the generation of content, others may engage in the option provided by PowerPoint to automatically generate slides, etc.

The manager knows that historical retention rates for users vary for the different kinds, e.g., a content producer is more likely to renew than a content consumer. The manager may set up a goal to increase the use of the app 106 by the users, with the expected benefit that users that engage more often are more likely to renew their subscriptions. The tools described herein assist the manager 124 to select hypotheses, estimate outcomes for testing the hypotheses, and validate each hypothesis to improve the retention of users 102.

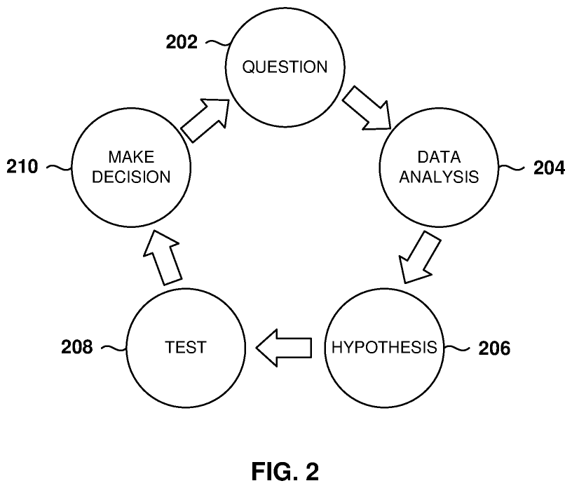

FIG. 2 illustrates the hypothesis generation and validation process, according to some example embodiments. The improvement process begins with a question 202, e.g., how to reduce cost, how to improve customer satisfaction, how to increase percentage of successful cases of self-help.

At operation 204, the data is analyzed to determine problems that can be improved, e.g., a high percentage of support calls after users try self-help options. Based on the data analysis, one or more hypothesis 206 are generated. For example, a hypothesis may be, “if we lower the price of the product by ten percent, we will increase sales and grow our revenue.”

The goal is to determine if an improvement would result from implementing the scenario outlined by the hypothesis. At operation 208, the hypothesis is tested to determine its validity. For example, A/B testing may be used to see the response of users of a product when a certain feature is present or not. A/B testing is a user experience research methodology that includes a randomized experiment with two variants, A and B, that define two values of the variable being tested. Typically, A/B testing observes the responses of users exposed to variant A (control group) and variant B (treatment group) and determines which of the two variants is more effective. By comparing the results from the control and treatment groups, a determination is made on whether the hypothesis provides an improvement. In some embodiments, the control group is for users where the software program is not changed, and the treatment group is for users exposed to a change in the program.

Based on the test results, a decision is made at operation 210 on whether to implement the improvement suggested by the hypothesis. The process may then be repeated by further data analysis and generation of hypothesis.

Embodiments provide tools for identifying and testing hypotheses. The tools provide several benefits to managers of a given product of service, the benefits including:
Identify a set of impactful hypotheses for metric growth (e.g., user growth or retention improvement) quickly with fine grain control over segment selection, and other experiment parameters;
Rank a set of hypotheses based on predicted impact, without having to test the hypotheses;
Understand the user base and the user behavior at an aggregated level; and
Identify desirable user behavior and target segment to further enhance user engagement, growth, and retention.

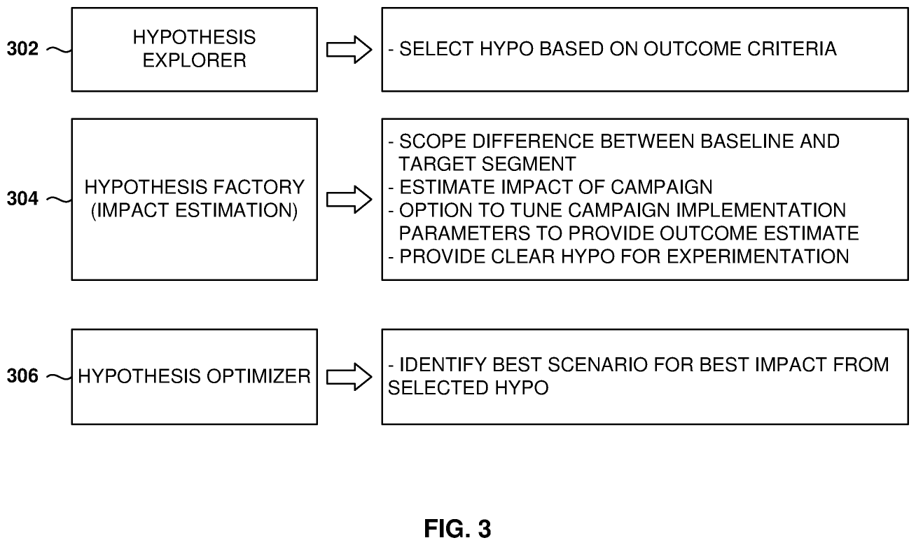

FIG. 3 is a high-level process description for hypothesis generation and impact estimation, according to some example embodiments. A hypothesis explorer 302 is a tool for selecting hypotheses (hypo) based on a desired outcome.

Hypothesis is a key element of experimentation and expecting product growth without the use of hypotheses is like expecting to find the way out of a jungle without a map. It is useful to identify a right hypothesis to conduct any experiment to positively influence product growth. An effective hypothesis comprises of the proposed change, the impact of the change, and the research backing it. The analytical framework helps to understand the user behavior within a certain product or service, identify the proposed changes, and estimate the impact if this change is implemented. Identifying a good and actionable hypothesis is generally a costly and time-intensive process to launch a successful experiment to drive user growth, engagement, and retention.

A hypothesis factory 304 is a tool for estimating the impact of implementing the change defined in the hypothesis. Further, a hypothesis optimizer 306 is a tool for selecting a hypothesis for testing based on the estimates of the hypothesis factory 304. The hypothesis optimizer 306 identifies the best scenario, or scenarios, that provide the best impact from the selected hypotheses.

The hypothesis explorer 302 helps to identify potential hypotheses from a large pool of different combination of parameter values. In some embodiments, the hypothesis explorer 302 assists in selecting a combination of a baseline segment presenting a first behavior, referred to as baseline scenario, and a target segment that presents a target behavior, referred to as a target scenario, to get the highest improvement, e.g., increase number of users, improve user retention, improve user satisfaction. A segment is a group of users that are similar with regards to at least one parameter. In some example embodiments, actions, action groups, or action stages may used to define the baseline and target segments.

The hypothesis explorer 302 tool provides options to the manager for entering the selection criteria (e.g., providing a ranking value to some segments), to identify the best hypothesis with the highest difference in the value of one performance parameter between the baseline segment and the target segment.

For example, users that used a certain feature in the app (users in the target segment) have highest retention than users that did not use the feature in the app (users in the baseline segment). The goal is to encourage members of the baseline segment to use the certain feature in order to move them into the target segment to increase retention. However, an app may have many features and many combinations of baseline and target segments, which makes it very difficult for a manager to narrow down the best options for improvement. The hypothesis explorer 302 tool helps the manager select the best combinations of baseline and target segments.

An action is an input from a user using an application that generates a response by the application. Related actions can be grouped in action groups (e.g., Print and Print preview). Further, an action stage, also referred to herein as simply a stage is a combination of action groups. In some embodiments, a stage may include combinations of actions and action groups.

The hypothesis explorer 302 tool identifies the combinations of baseline and target segments that result in higher differences between the key parameter, or parameters, that differentiates the segments. After identifying stages for baseline and target behaviors scenarios and the outcome difference between them, the hypothesis explorer 302 identifies a potential hypothesis for an experiment by illustrating a needed behavior change to encourage baseline users to conduct actions that would move them to the target segment. The same process can be repeated for other selection criteria (e.g., people with highest scenario difference in the retention).

Next, the hypothesis factory 304 is used to estimate the expected impact from the selected hypothesis after selecting user segment and target behavior. In some embodiments, the hypothesis is formatted as follows: if a variable is selected, then some results are expected due to a certain rationale.

The variable is an element that can be modified, added, or eliminated to produce the desired outcome. The rationale is a demonstration that the hypothesis is workable (e.g., what is known about users that indicates that the hypothesis is correct).

For example, the actions that differentiate the baseline segment from the target segment are identified, and the difference in performance metric indicates the intrinsic value. The hypothesis factory 304 will estimate the improvement (e.g., lift in performance value) when a user is converted to the target segment.

The hypothesis factory 304 provides flexibility in terms of selecting hypothesis parameters, e.g., percentage of segment reach, percentage of interaction with campaign, and percentage of retention lift achieved via this campaign. Additionally, the hypothesis factory 304 provides overall metrics for comparing the users in the baseline and target segments.

After the manager selects the desired parameters in the hypothesis factory 304, a campaign is created and saved in memory. These parameters are then used by the hypothesis optimizer 306.

In one example, a dataset contained 6,700 difference hypotheses. In order to evaluating each scenario, the hypothesis factory 304 identified the best hypothesis given certain criteria and visualize information regarding the hypothesis differences between baseline and target segments.

In some example embodiments, the hypothesis factory implements a method with the following operations:
1. Select baseline and target segment size (e.g., 100,000 users or more);
2. Select segment size delta difference (e.g., 100,000 users or more);
3. Select a minimum lift in retention when moving users from baseline to target segment (difference between baseline and target hypothesis);
4. Rank the hypothesis based on at least one impact metric;
5. Select one or more from the top hypothesis; and
6. Present on a User Interface (UI) the differences (e.g., related to the performance metric) between the baseline and target segments for each hypothesis.

For example, the manager wants to know the impact of moving users from a low-retention baseline segment to a high-retention target segment in order to lower churning (e.g., lose users) and improve renewal conversion rates. The hypothesis factory 304 calculates the improvement per each unique transition between segments, and the results are used to determine campaigns for experimentation, compare differences in user actions, and estimate the impact of the lift in retention or user growth.

The analytical framework is able to effectively rank a set of hypotheses generated with the hypothesis factory 304. Once impact assessment is performed for all the hypotheses created by the hypothesis factory 304, the hypothesis optimizer 306 assists in prioritizing these hypotheses, and make a decision about which hypothesis to pursue for experimentation. The goal of the hypothesis optimizer 306 is to compare and rank these hypotheses. This way, a manager can review these generated hypotheses in one place, rank them (from highest to lowest impact), and compare them based on impact or campaign parameters.

There are several benefits from the hypothesis-tool framework that help managers improved their products or services:
1. Identify a set of impactful hypotheses for metric growth (e.g., user growth or retention improvement) with fine-grain control over segment selection and other experiment parameters;
2. Rank a set of hypotheses based on predicted impact;
3. Understand the app user base and user behavior at an aggregated level; and
4. Identify desirable user behavior and target segment to further enhance user engagement, growth, and retention.

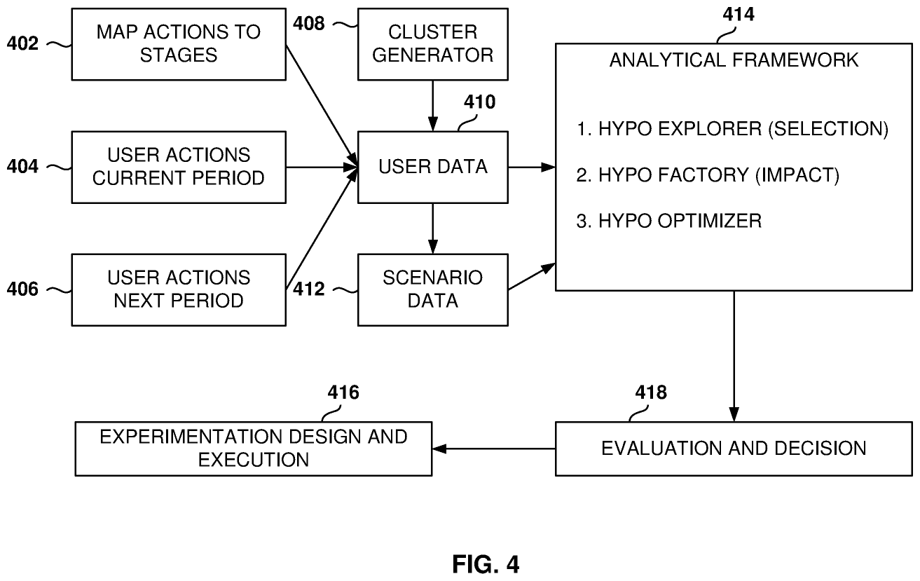

FIG. 4 illustrates the data management for the analytical framework to evaluate hypotheses, according to some example embodiments. A data ingestion layer is utilized to ingest different input data based on the application. In some embodiments, the inputs to the analytical framework 414 are a set of vectors representing the aggregated level of user data 410 and scenario data 412. The output is a set of parameters, used for evaluation and decision 418, that include campaign parameters, estimates of hypothesis impact, and hypothesis ranking. This output is used to identify actionable hypotheses with the highest impact.

In some example embodiments, the user data 410 includes at least one of mapping actions to stages 402, user actions (e.g., activities in the app) in the current period 404, and user actions observed for the next period 406. The user data 410 is anonymized to protect user privacy by deleting or obfuscating Personal Identifiable Information (PII).

The scenario data 412 includes information on possible hypotheses, such as comparisons between baseline and target segments, estimated lift in performance metric for a transition, etc. In some example embodiments, the scenario data represents a list of different combinations of stages and their respective impact metrics.

Additionally, a cluster generator 408 is used for clustering users with similar characteristics into groups, referred to herein as personas. The data (e.g., user actions) is then consolidated for users in the same cluster. When the number of users of the app is large (e.g., in the millions), then clustering simplifies the processing of the user action data. In some example embodiments, the clustering is performed using an unsupervised machine-learning model, but other clustering methods may be used.

In some example embodiments, the persona for each cluster is defined based on app usage. For example, for users of PowerPoint, personas may be defined for editors (e.g., users that create slides), users of the AI tool, consumers (e.g., readers of PowerPoint slides), advanced editors (e.g., users that used certain advanced features), etc. Additionally, segments may be defined that combine two or more features or stages, such as users that edit and present.

A data processing layer performs the computations and algorithms for the analytical framework 414. In some example embodiments, an Application Programming Interface (API) is provided to facilitate experimentation using complementary tools and the use of cloud services.

A data visualization layer is used to present the hypothesis tool on a computer display. Any visualization tool may be used, such as Power BI (Business Intelligence) from Microsoft, and other tools that may be used via an API (e.g., Tableau or static website using visualization libraries such d3, plotly).

In some example embodiments, the hypothesis evaluation process begins with the data preparation, which is conducted by pulling the user data 410, apply filters if needed, join the data with the action-stage mapping, aggregate the data to the user level, and then the aggregate the data for each scenario to produce unique combinations of different scenarios.

Additional calculations are then performed based on the hypothesis parameters chosen by the manager, and a dashboard is presented to allow the manager to select segment and target behavior scenarios. The expected outcome of each campaign is then displayed (e.g., showing the results of moving users from the baseline segment to the target segment, user counts, and retention levels).

After the evaluation and decision operation 418, the experiment, also referred to herein as a campaign, is designed and executed at operation 416. In some example embodiments, A/B testing is used to determine the impact of implementing the scenario outlined by the hypothesis.

The hypothesis generator creates the experiment template, which includes calculating estimates, determining how long the experiment should last, and defining how to perform the A/B test.

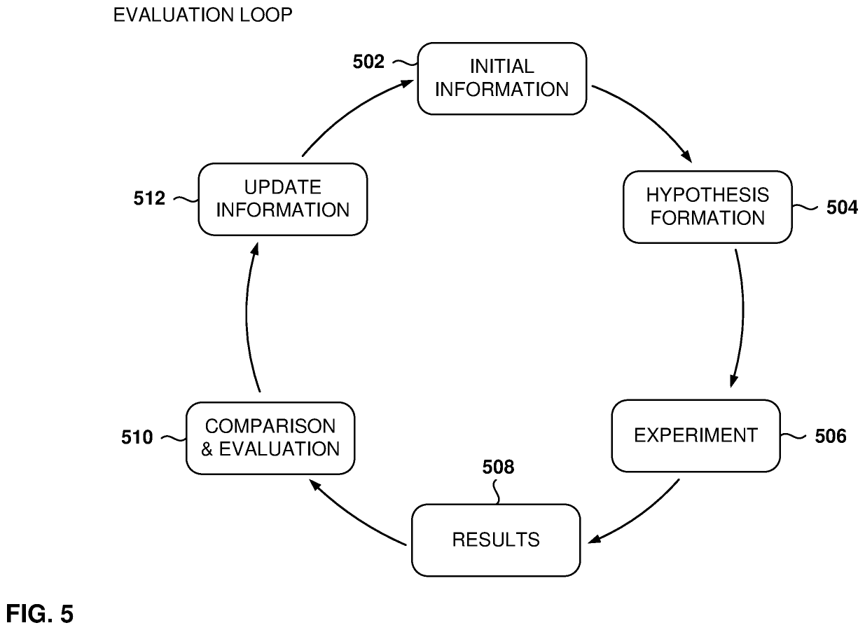

FIG. 5 illustrates the evaluation loop for ongoing scenario evaluation and improvement, according to some example embodiments. The hypothesis selection and validation process may be repeated multiple times. A high-level, the process begins at operation 502 to collect the initial information about the application, user activities, performance metrics, etc. At operation 504, hypotheses are formed, e.g., with the hypothesis factory.

Once a hypothesis is selected, at operation 506, an experiment is performed to determine results 508 that indicate if the hypothesis causes a performance improvement. At operation 510, the results are evaluated by comparing the estimate from the hypothesis factory and the experiment results. The app information is updated 512 based on the observed results, and the updated information may then be used as the initial information for a new cycle of hypothesis selection and testing.

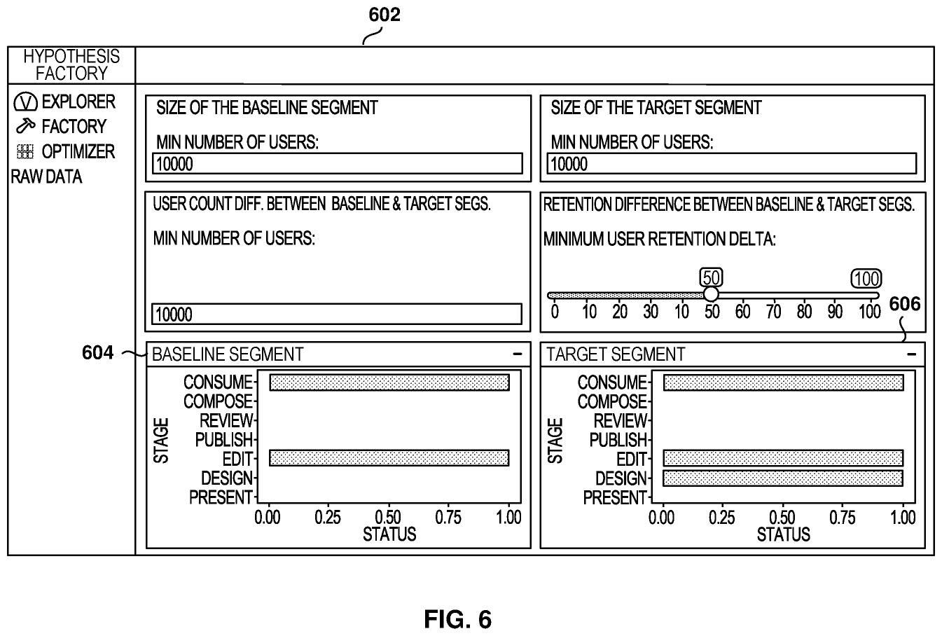

FIG. 6 is a sample user interface (UI) 602 for the hypothesis explorer, also referred to as the hypothesis factory, which is part of the analytical framework. The UI 602 includes options for configuring a hypothesis. In this example, options are presented for entering the minimum number of users for analyzing the baseline and target segments (e.g., 10,000 minimum). The goal is to move users from the baseline segment to the target segment to improve a performance metric (e.g., retention rate). A third option is presented for entering a minimum number of users between the baseline and target segments.

Another option is for identifying a minimum change in the performance metric (e.g., retention rate), by identifying the minimum level of user retention delta between the baseline and the target segments, a parameter called user retention data. In this example, a sliding bar is provided for the manger to configure the minimum user retention delta.

Chart 604 includes information about the activities of users in the baseline segment, referred to as stages. In this example, the stages include consume, compose, review, publish, edit, design, and present. Similarly, chart 606 provide the information about the activities of users in the target segment.

In this example, the difference between the baseline segment and the target segment is the use of the designer stage in the program. Thus, the goal of the hypothesis experimentation is to have the baseline of users start using advanced features, which would move them to the target segment with a higher retention rate.

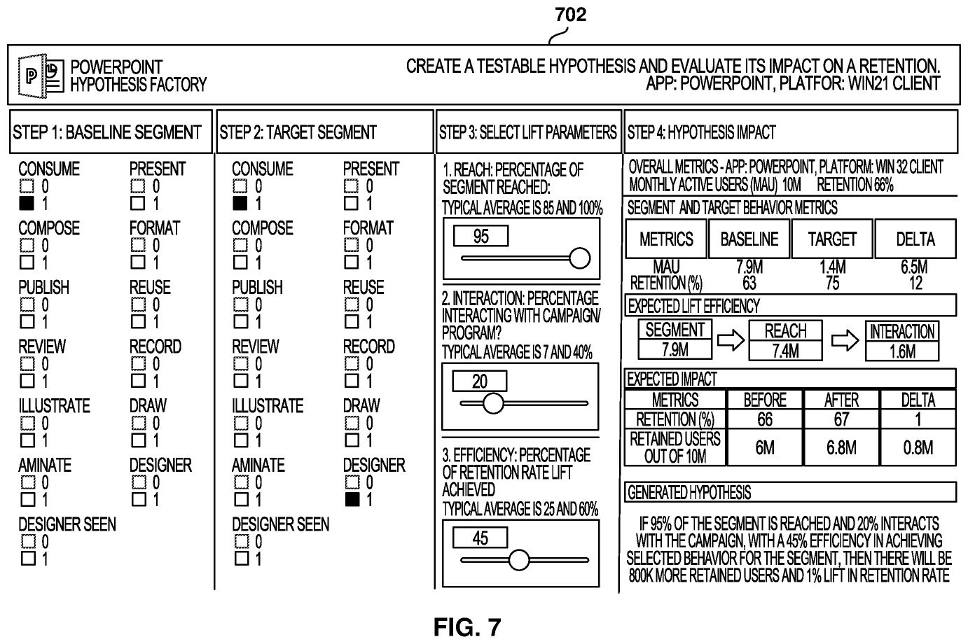

FIG. 7 is a sample UI 702 for the configuration and analysis of hypotheses, according to some example embodiments. The UI 702 includes several steps for configuring the generation of hypotheses.

At step one, the baseline segment is selected. In the illustrated example, a plurality of stages (e.g., accessed features in the app) associated with the baseline segment are selected. In this example, the stage selection is binary, that is, they can have a value of 1 for present or a value of zero for not present. The stages are independent from each other, so the manager may select any combination of stages in step one. In the illustrated example, the user has selected the consume stage.

At step two, the target segment is selected by selecting the stages for the baseline segment from the same plurality of stages available in step one. In the illustrated example, the target segment includes the consume and the designer stages, which means that the difference between the baseline segment and the target segment is the selection of the designer stage.

Since the stages are independent, the possible combinations for setting up hypothesis is very large and testing each of the possible combinations in the real-world environment will consume a large amount of time and resources. By knowing which action stages to select for baseline and target segments and estimating the effect of these hypothesis before actual testing, the manager is able to select hypotheses with a high rate of return.

At step 3, the UI 702 provides input options for selecting the desired lift in the performance metric. In the illustrated example, there are three configurable parameters in step three. Parameter 3.1 is for the reach, which is the percentage of segment reached in the campaign for the testing of the hypothesis. A sliding bar is provided to enter the value, 95 percent in this example. An example of a campaign for Microsoft Word users is, “It looks like you just purchased Word; did you know about this great AI feature of Word that can help you craft intelligent documents in no time?” If the user engages with the campaign, then the campaign is considered successful for that user.

Parameter 3.2 determines the percentage of users in the baseline segment that interact with the campaign. For example, the campaign may offer a renewal incentive (e.g., reduced price renewal) if the user activates the desired feature. Further, parameter 3.3 is for efficiency, which is the percentage of retention rate left achieved when moving a user from the baseline segment to the target segment.

After the user selects the options in steps 1-3, step 4 illustrates the expected performance of the hypothesis if carried to practice. The goal is to find the best baseline and target segments that generate the most impact, e.g., the best improvement on the performance metric.

At the top of step 4, the UI 702 indicates the values of some parameters for the simulation, which in this example are the application (PowerPoint™), the device (Windows 32 client), the number of monthly active users (MAU) (10 M) and the current retention rate (66%).

Additionally, a table is presented where the first column is the name of the metric (MAU and retention rate), the second column is for the values of the baseline segment (7.9 MAU and 63%), the third column is for the values of the target segment (1.4 M and 75%), and the fourth column is for the different between the baseline and target segments.

Further, under step four, a summary of the expected lift efficiency in the performance parameter is presented. In this example, the segment has 7.9 M users, the reach of the campaign is 7.4 M and the interactions with the campaign are 1.6 M users responding. The efficiency metric in this case is the percentage of retention lift achieved.

Further, a second table shows the impact of implementing the hypothesis, with the first column for the metric name, the second column for the values before the campaign, the third column for the value after the campaign, and the fourth column for the difference between the before and after. The first row shows the retention rate, and the second row shows the number of retained users.

Further, at the bottom of step four, the hypothesis is presented, and in this example, the generated hypothesis is, “if 95% of the segment is reached and 20% interacts with the campaign, with a 45% efficiency in achieving the selected behavior for the segment, then there will be 800K more retained users and a 1% lift in the retention rate.”

Thus, the hypothesis factory allows the manager to evaluate the hypothesis without having to actually test it in the real world with users. Another option of the hypothesis factory is to automatically generate a large number of hypothesis and calculate the efficiency improvement for each of the hypothesis. The hypotheses are then ranked according to the efficiency improvement and then presented to the manager sorted by efficiency.

In some example embodiments, wildcards are available to select a plurality of hypothesis. For example, the manager may select that the consume stage value may be zero or one, present value may be zero or one, published value may be zero or one, designer value may be zero or one, and animate value may be zero or one. This would generate a large number of possible hypothesis and the hypothesis factory would rank them according to efficiency lift. For example, thousands, or even millions of hypothesis, may be generated and estimated, which is a great performance improvement over having the manager testing each possible combination in the real world. The manager is able to select hypotheses with the best expected improvement.

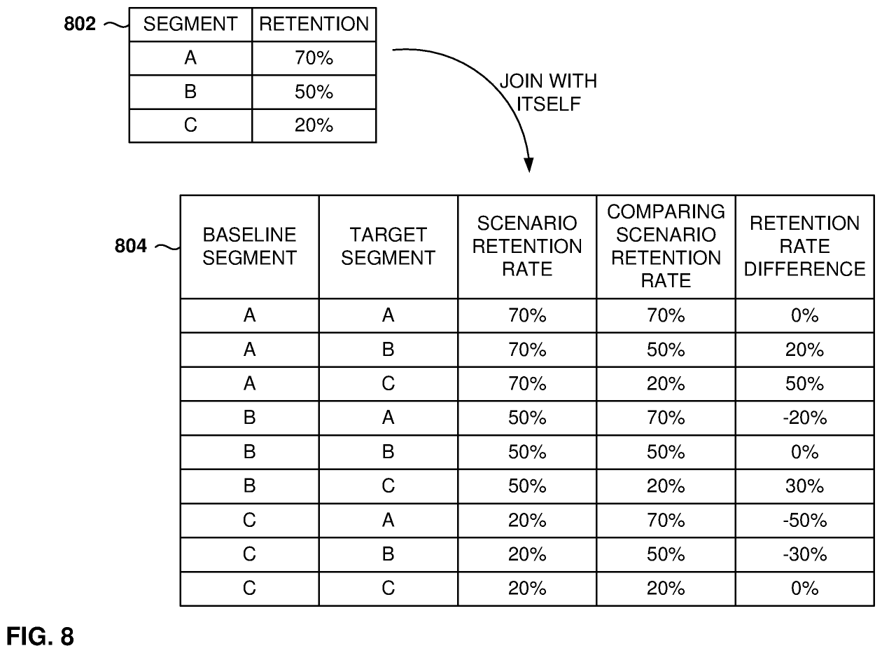

FIG. 8 illustrates the joining of segments for determining the impact of segment conversion, according to some example embodiments. In some example embodiments, a table 804 is created to compare segments, an operation called joining the segments with themselves.

Initially, a table 802 includes a row for each segment and one more columns for one or more performance metrics. In this example, the performance metric is the retention rate. The table 804 is created by generating rows to cover all segment combinations. In the illustrated example, table 802 includes three segments A, B, and C, with respected retention rates of 70%, 50%, and 20%.

The table 804 includes nine rows, with each row corresponding to a different combination of segments. The first column of table 804 is for a baseline segment, and the second column is for a target segment. Thus, there nine rows for the different segment combinations, including pairs of (A, A), (A, B), (A, C), (B, A), etc.

The third column and fourth column are generated by listing the retention rate of the baseline and target segments. For example, the first row includes retention rates of 70% and 70%, the second row to retention rates of 70% for segment A and 50% for segment B, etc.

The last column is the difference in the retention rates between the target and baseline segments, that is, the retention rate of the target segment minus the retention rate of the baseline segment.

In the illustrated example, the highest retention rate of 50% corresponds to the combination (A, C), which indicates that there would be a great performance improvement if users from segment A migrated to become users in segment B.

In practice, there could be hundreds or thousands of combinations, so automatically ranking the combinations, by checking the best retention rate improvements, assists in prioritizing the calculations for the hypotheses associated with these transitions.

In some example embodiments, additional columns are added to table 804 to include the sizes of the segments, and optionally, other parameters associated with the baseline and target segments, such as default campaign effectiveness when migrating from the baseline segment to the target segment. Additionally, table 804 may also include columns with values of the results from previous campaigns, (e.g., the effectiveness of our campaign when migrating a baseline segment A to target segment B).

In order example embodiments, a table for comparing segments is formed instead by having a column for each segment and then creating combinations in rows by marking the baseline segment (e.g., with a 1), and the target segment (e.g., with a 2), and the other segments with a different value (e.g., a 0).

Whatever format is selected for creating a comparison table, the goal is to have a row for each possible combination and columns that identify the difference in performance metric. After the table is created, the table may be sorted according to the improvement in performance metric to generate a list for exploring hypotheses, with the transitions ranked according to the performance improvement.

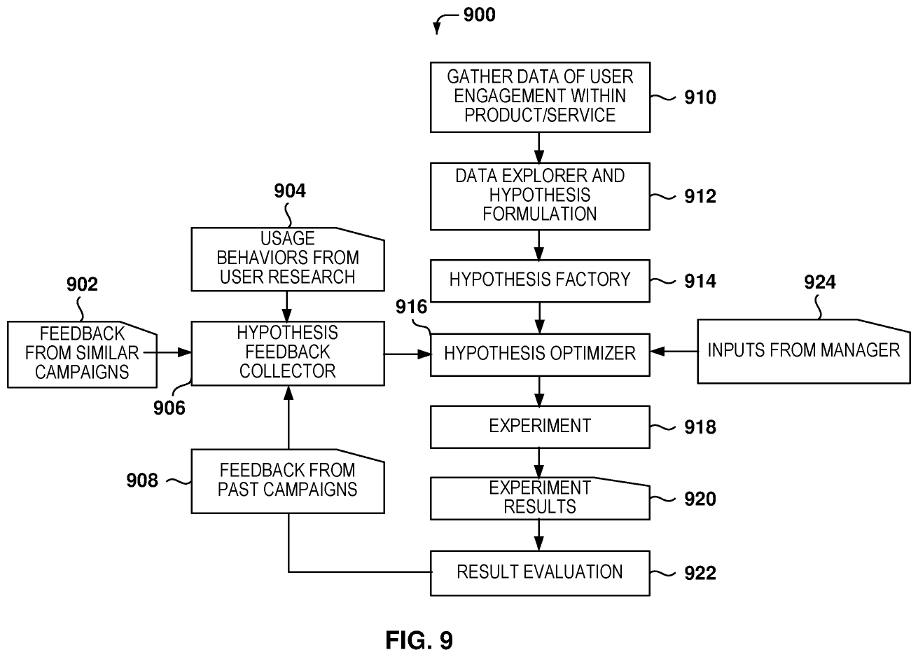

FIG. 9 is a flowchart of a method 900 for hypothesis feedback and evaluation, according to some example embodiments. While the various operations in this flowchart are presented and described sequentially, one of ordinary skill will appreciate that some or all of the operations may be executed in a different order, be combined or omitted, or be executed in parallel.

Operation 910 is for gathering data regarding user engagement with the product or service. For example, user data regarding features use when engaging with an application. From operation 910, the method 900 flows to operation 912 for exploring hypothesis formulation, such as by ranking possible hypothesis on segment transition, as described above with reference to FIG. 8.

At operation 914, the hypothesis factory tool provides options for selecting hypotheses, as described above in reference to FIG. 7. At operation 916, the hypothesis optimizer selects one or more hypothesis scenarios for testing and implementation based on the estimates of the hypothesis factory. The hypothesis optimizer utilizes the inputs from the manager regarding the scenarios, such as desired segments to explore, etc.

The hypothesis optimizer also receives information from the hypothesis feedback collector regarding user behaviors from user research 904 (e.g., certain user behavior inputs or action usage derived from user research), the feedback from past campaigns 908, and the feedback from similar campaigns 902 (e.g., where the baseline segment or target segment overlaps with the hypothesis scenario).

After the hypothesis optimizer is configured for a particular hypothesis, and experiment 918 is performed to test the hypothesis, e.g., a campaign directed to users of the application.

The experiment results 920 of the campaign are then presented on a user interface, e.g., conversion rates, efficiency, etc. The results are evaluated 922 to determine if the campaign was successful and what kind of return was obtained from the experiment.

An aspect of the analytical framework is the integration of the feedback from the experiment results, feedback from other similar experiments run in the past, or new input variables from the manager 924, which have not been considered yet while forming the hypothesis for experimentation. Gathering feedback signals from historical data as well as managers helps in the hypothesis evaluation of success or failure, impact estimation on the target variable, and adding more combinations for the generation of new hypotheses. This feedback analysis helps to answer whether the hypotheses moved the metrics after conducting the A/B experiment, and provides insight on how good the hypothesis was in comparison to the real outcome.

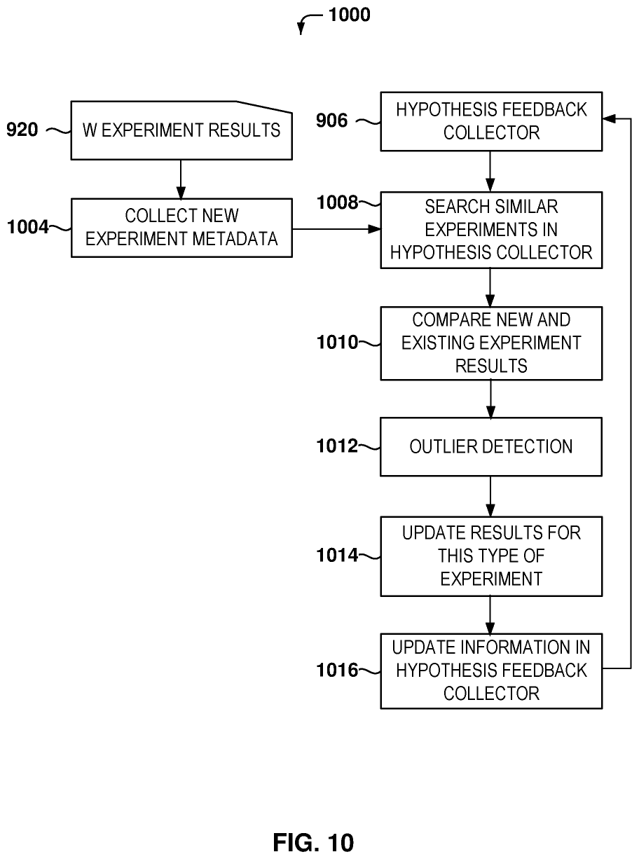

FIG. 10 is a flowchart of a method 1000 for hypothesis feedback and evaluation, according to some example embodiments. While the various operations in this flowchart are presented and described sequentially, one of ordinary skill will appreciate that some or all of the operations may be executed in a different order, be combined or omitted, or be executed in parallel.

At operation 1004, new experiment metadata is collected based on the experiment results 920, where the metadata includes information about the campaign, such as number of users participating, performance metrics, evaluation metrics, etc.

At operation 1008, a search is performed for similar experiments at the hypothesis collector, based on the on the hypothesis feedback collector 906 and the experiment metadata.

At operation 1010, the experiment results are analyzed, e.g., by comparing the results from past experiments and new experiments. Further, at operation 1012, outliers are detected and then the corresponding results discarded for the outliers.

At operation 1014, the results are updated based on the outlier detection. In some example embodiments, the estimate for each experiment update utilizes a Bayesian approach, initially based on an estimate belief (e.g., obtained from a user research or manager input), and then updated as more and more data from experiments is captured. Eventually, as more data is available, the data-driven approach will be based solely on experiment results. At operation 1016, the updated information is provided to the hypothesis feedback collector 906 for future used in new experiments.

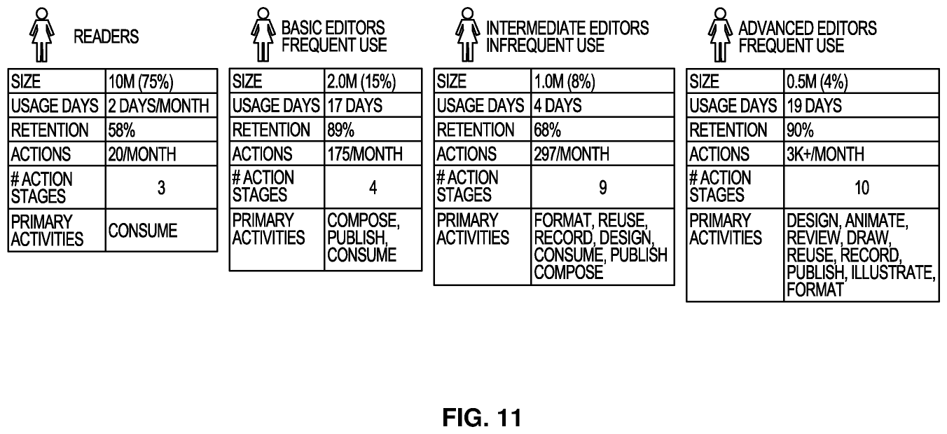

FIG. 11 illustrates an example clustering of users, according to some example embodiments. In the illustrated example, the clustering process has identified, based on the usage pattern over a period of 30 days, four different types of users of the PowerPoint application: readers, basic editors with frequent use, intermediate editors with infrequent use, and advanced editors with frequent use.

The segmentation was done using K-Means algorithm, but any other clustering algorithm may be used. The feature set used included active days, action count intensity, action diversity, and core actions (e.g., “consume,” “present,” “compose,” “format,” “publish,” “design,” “reuse,” “share,” “animate”).

The results for each cluster are presented in respective tables, including the size of the cluster, the usage data, the retention rate the number of actions, the number of journey stages, and the primary activities.

The identified clusters are then used to determine possible retention-rate improvement by having campaigns to move users from one cluster to another, that is, moving users from a baseline segment to a target segment.

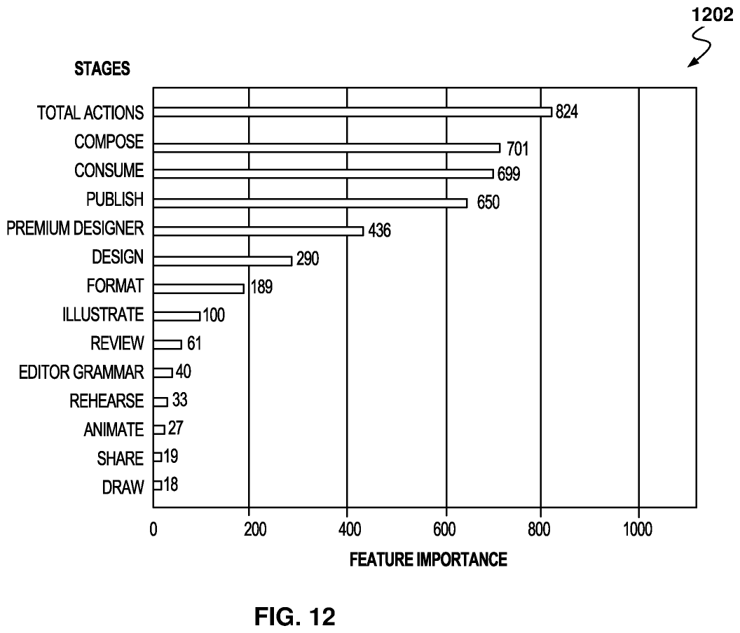

FIG. 12 illustrates a sample evaluation of stages for evaluation by the evaluation model, according to some example embodiments. In one example embodiment, stages were identified for evaluation. A machine-learning model, e.g., a LightGBM model, was used to identify the stages which are drivers of retention for the user segment, but other models may also be used.

The LightGBM model is a gradient boosting framework which uses tree-based learning algorithms. It is an example of an ensemble technique that combines weak individual models to form a single accurate model. In some example embodiments, the features include total number of actions, compose, consume, publish, premium designer, design, format, illustrate, review, editor grammar, rehearse, animate, share, and draw.

The chart 1202 shows the feature importance value for each of the stages, e.g., “total actions” had the highest impact and “draw” had the lowest impact. For example, for the reader segment (consume=true, other journey stages=false), it was observed that retained users perform more record and compose actions when compared to non-retained users. Similarly, for the basic editor segment, the results suggest that retained users do more actions to publish activities and have a high rate of compose actions. These drivers are further used in the hypothesis factory for identifying the base and the target segment for the hypothesis generation.

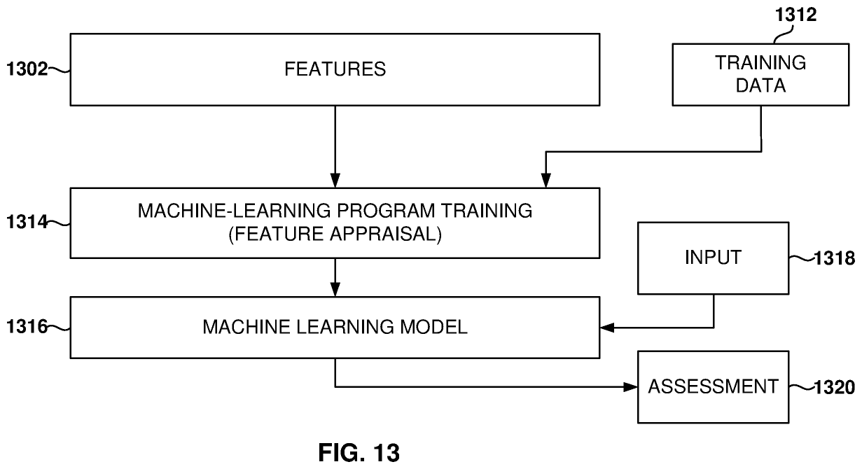

FIG. 13 illustrates the training and use of a machine-learning model, according to some example embodiments. In some example embodiments, machine-learning (ML) models 1316, are utilized to cluster users, assess value of product features for retention, or estimate if a user will be retained over a predetermined period of time.

Machine Learning (ML) is an application that provides computer systems the ability to perform tasks, without explicitly being programmed, by making inferences based on patterns found in the analysis of data. Machine learning explores the study and construction of algorithms, also referred to herein as tools, that may learn from existing data and make predictions about new data. Such machine-learning algorithms operate by building an ML model 1316 from example training data 1312 in order to make data-driven predictions or decisions expressed as outputs 1320 or assessments. Although example embodiments are presented with respect to a few machine-learning tools, the principles presented herein may be applied to other machine-learning tools.

Data representation refers to the method of organizing the data for storage on a computer system, including the structure for the identified features and their values. In ML, it is typical to represent the data in vectors or matrices of two or more dimensions. When dealing with large amounts of data and many features, data representation optimization helps so the training is able to identify the correlations within the data faster.

There are two common modes for ML: supervised ML and unsupervised ML. Supervised ML uses prior knowledge (e.g., examples that correlate inputs to outputs or outcomes) to learn the relationships between the inputs and the outputs. The goal of supervised ML is to learn a function that, given some training data, best approximates the relationship between the training inputs and outputs so that the ML model can implement the same relationships when given inputs to generate the corresponding outputs. Unsupervised ML is the training of an ML algorithm using information that is neither classified nor labeled, and allowing the algorithm to act on that information without guidance. Unsupervised ML is useful in exploratory analysis because it can automatically identify structure in data.

Common tasks for supervised ML are classification problems and regression problems. Classification problems, also referred to as categorization problems, aim at classifying items into one of several category values (for example, is this object an apple or an orange?). Regression algorithms aim at quantifying some items (for example, by providing a score to the value of some input). Some examples of commonly used supervised-ML algorithms are Logistic Regression (LR), Naive-Bayes, Random Forest (RF), neural networks (NN), deep neural networks (DNN), matrix factorization, and Support Vector Machines (SVM).

Some common tasks for unsupervised ML include clustering, representation learning, and density estimation. Some examples of commonly used unsupervised-ML algorithms are K-means clustering, principal component analysis, and autoencoders.

The training data 1312 comprises examples of values for the features 1302. In some example embodiments, the training data comprises labeled data with examples of values for the features 1302 and labels indicating the outcome, such as user is retained when a user responds to a campaign. The machine-learning algorithms utilize the training data 1312 to find correlations among the features 1302 that affect the outcome. A feature 1302 is an individual measurable property of a phenomenon being observed. The concept of a feature is related to that of an explanatory variable used in statistical techniques such as linear regression. Choosing informative, discriminating, and independent features is important for effective operation of ML in pattern recognition, classification, and regression. Features may be of different types, such as, numeric, strings, categorical, and graph. A categorical feature is a feature that may be assigned a value from a plurality of predetermined possible values (e.g., this animal is a dog, a cat, or a bird).

In one example embodiment, the features 1302 may be of different types, such as actions, action groups, and action stages. In one example embodiment, the features 1302 include the action stages described with reference to FIG. 12. The features include any combination of total number of actions, compose, months since subscription start, consume, publish, command diversity, premium designer, record, design, format, reuse, illustrate, review, editor grammar, rehearse, animate, auto alt text, share, premium editor style, and draw. Any combination of features may be used to train the machine-learning program. Further, some embodiments may use additional features.

During training 1314, the ML program, also referred to as ML algorithm or ML tool, analyzes the training data 1312 based on identified features 1302 and configuration parameters defined for the training. The result of the training 1314 is the ML model 1316 that is capable of taking inputs to produce assessments.

Training an ML algorithm involves analyzing large amounts of data (e.g., from several gigabytes to a terabyte or more) in order to find data correlations. The ML algorithms utilize the training data 1312 to find correlations among the features 1302 that affect the outcome 1320. In some example embodiments, the training data 1312 includes labeled data, which is known data for one or more features 1302 and one or more outcomes.

The ML algorithms usually explore many possible functions and parameters before finding what the ML algorithms identify to be the best correlations within the data; therefore, training may make use of large amounts of computing resources and time.

When the ML model 1316 is used to perform an assessment, input 1318 is provided as an input to the ML model 1316, and the ML model 1316 generates the output 1320.

In some embodiments, a first ML model 1316 is used to cluster users, e.g., clusters of users presented in FIG. 11. The clustering is performed used unsupervised learning.

In other embodiments, a second ML model 1316 is used to estimate if a user will be retained over a predetermined period of time. For a given user, the given user information and the hypothesis information are provided as an input, and the second ML model 1316 provides an output that is the retention rate of the given user during a predetermined period (e.g., over a period covering the next three months). The second ML model 1316 may also provide an output indicating the probability that the user in the baseline segment will transfer to the target segment over the predetermined period.

The ML program training 1314 assess the value of the product features for retention, such as the stages presented above with reference to FIG. 12. The training data includes usage data related to how users are interacting with the app, and which users are retained over a period of time (e.g., 3 months, six months, a year).

A third ML model 1316 is used to evaluate the effect of campaigns given a hypothesis. The information about the hypothesis is provided as input 1318 (e.g., information on baseline and target segments, campaign data), and the third ML model 1316 provides an assessment that includes predictions for the results of the campaign, such as conversion rates. Some metrics regarding the estimates for running a campaign are described above with reference to FIG. 7.

In some example embodiments, results obtained by the model 1316 during operation (e.g., outputs 1320 produced by the model in response to inputs) are used to improve the training data 1312, which is then used to generate a newer version of the model. Thus, a feedback loop is formed to use the results obtained by the model to improve the model.

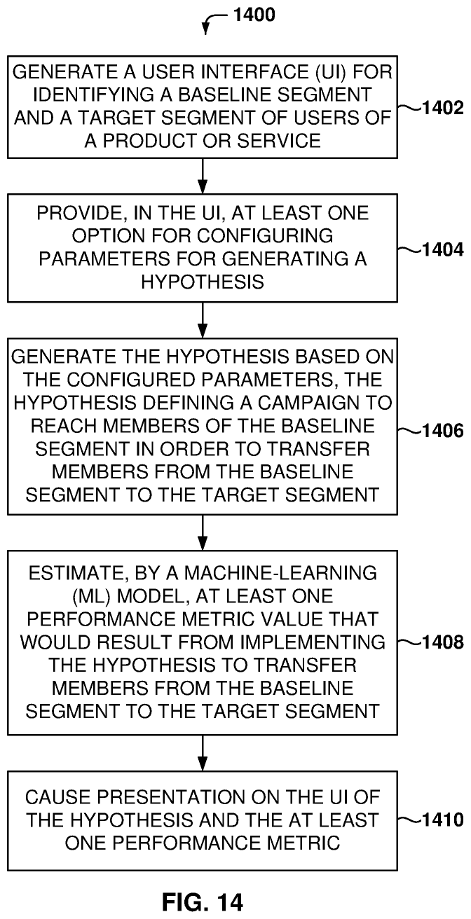

FIG. 14 is a flowchart of a method 1400 for hypothesis generation and evaluation, according to some example embodiments. While the various operations in this flowchart are presented and described sequentially, one of ordinary skill will appreciate that some or all of the operations may be executed in a different order, be combined or omitted, or be executed in parallel.

Operation 1402 is for generating a UI for identifying a baseline segment and a target segment of users of a product or service.

From operation 1402, the method 1400 flows to operation 1404 to provide, in the UI, at least one option for configuring parameters for generating a hypothesis.

From operation 1404, the method 1400 flows to operation 1406 for generating the hypothesis based on the configured parameters. The hypothesis defines a campaign to reach members of the baseline segment in order to transfer members from the baseline segment to the target segment.

From operation 1406, the method 1400 flows to operation 1408 to estimate, by a ML model, at least one performance metric value that would result from implementing the hypothesis to transfer members from the baseline segment to the target segment.

Further, from operation 1408, the method 1400 flows to operation 1410 for causing presentation on the UI of the hypothesis and the at least one performance metric.

In one example, the ML model receives as input information about a user and information about the hypothesis, wherein the ML model provides an output that is a retention rate of the user during a predetermined period.

In one example, generating the hypothesis further comprises identifying a plurality of hypotheses based on a plurality of features of an application. Each hypothesis identifies a transition from a potential baseline segment to a potential target segment based on values of the features assigned to the potential baseline segment and the potential target segment.

In one example, the method 1400 further comprises determining, for a plurality of combinations of baseline segment and target segment, a value of a performance improvement for transferring users from the potential baseline segment to the potential target segment; and ranking the plurality of combinations based on the value of the performance improvement.

In one example, the ML model is trained with training data comprising values for at least one feature from a plurality of features, the plurality of features comprising total number of actions, compose, months since subscription start, consume, publish, command diversity, premium designer, record, design, format, reuse, illustrate, review, editor grammar, rehearse, animate, auto alt text, share, premium editor style, or draw.

In one example, the method 1400 further comprises causing presentation on a feature UI of the features and a corresponding value for a feature importance for improving the performance metric.

In one example, the method 1400 further comprises obtaining usage data from a plurality of users of the product or service, and clustering, by an unsupervised ML model, the plurality of users into two or more clusters of users.

In one example, the information for each cluster comprises a size of the cluster, a usage rate of the product or service, a retention rate for the cluster, and activities associated with the cluster.

In one example, the product is a software application used by the users, wherein features associated with the ML model include values regarding how the users utilize multiple features of the software application.

In one example, the method 1400 further comprises causing presentation of a hypothesis-factory UI to present information on the baseline segment, the target segment and a difference in performance between the baseline segment and the target segment.

In view of the disclosure above, various examples are set forth below. It should be noted that one or more features of an example, taken in isolation or combination, should be considered within the disclosure of this application.

Another general aspect is for a system that includes a memory comprising instructions and one or more computer processors. The instructions, when executed by the one or more computer processors, cause the one or more computer processors to perform operations comprising: generating a user interface (UI) for identifying a baseline segment and a target segment of users of a product or service; providing, in the UI, at least one option for configuring parameters for generating a hypothesis; generating the hypothesis based on the configured parameters, the hypothesis defining a campaign to reach members of the baseline segment in order to transfer members from the baseline segment to the target segment; estimating, by a ML model, at least one performance metric value that would result from implementing the hypothesis to transfer members from the baseline segment to the target segment; and causing presentation on the UI of the hypothesis and the at least one performance metric.

In yet another general aspect, a machine-readable storage medium (e.g., a non-transitory storage medium) includes instructions that, when executed by a machine, cause the machine to perform operations comprising: generating a user interface (UI) for identifying a baseline segment and a target segment of users of a product or service; providing, in the UI, at least one option for configuring parameters for generating a hypothesis; generating the hypothesis based on the configured parameters, the hypothesis defining a campaign to reach members of the baseline segment in order to transfer members from the baseline segment to the target segment; estimating, by a ML model, at least one performance metric value that would result from implementing the hypothesis to transfer members from the baseline segment to the target segment; and causing presentation on the UI of the hypothesis and the at least one performance metric.

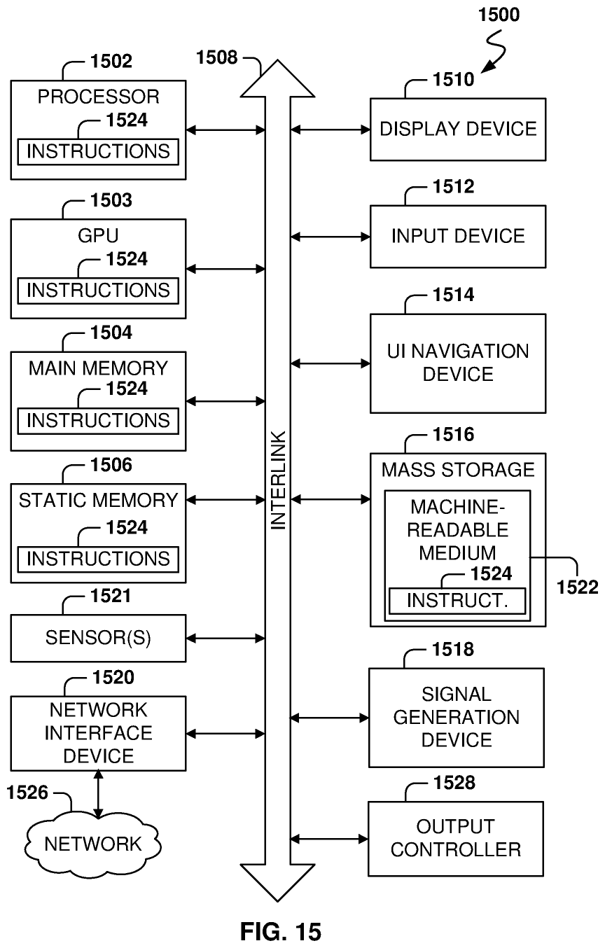

FIG. 15 is a block diagram illustrating an example of a machine 1500 upon or by which one or more example process embodiments described herein may be implemented or controlled. In alternative embodiments, the machine 1500 may operate as a standalone device or may be connected (e.g., networked) to other machines. In a networked deployment, the machine 1500 may operate in the capacity of a server machine, a client machine, or both in server-client network environments. In an example, the machine 1500 may act as a peer machine in a peer-to-peer (P2P) (or other distributed) network environment. Further, while only a single machine 1500 is illustrated, the term “machine” shall also be taken to include any collection of machines that individually or jointly execute a set (or multiple sets) of instructions to perform any one or more of the methodologies discussed herein, such as via cloud computing, software as a service (SaaS), or other computer cluster configurations.

Examples, as described herein, may include, or may operate by, logic, a number of components, or mechanisms. Circuitry is a collection of circuits implemented in tangible entities that include hardware (e.g., simple circuits, gates, logic). Circuitry membership may be flexible over time and underlying hardware variability. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits) including a computer-readable medium physically modified (e.g., magnetically, electrically, by moveable placement of invariant massed particles) to encode instructions of the specific operation. In connecting the physical components, the underlying electrical properties of a hardware constituent are changed (for example, from an insulator to a conductor or vice versa). The instructions enable embedded hardware (e.g., the execution units or a loading mechanism) to create members of the circuitry in hardware via the variable connections to carry out portions of the specific operation when in operation. Accordingly, the computer-readable medium is communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry, at a different time.

The machine (e.g., computer system) 1500 may include a hardware processor 1502 (e.g., a central processing unit (CPU), a hardware processor core, or any combination thereof), a graphics processing unit (GPU) 1503, a main memory 1504, and a static memory 1506, some or all of which may communicate with each other via an interlink (e.g., bus) 1508. The machine 1500 may further include a display device 1510, an alphanumeric input device 1512 (e.g., a keyboard), and a user interface (UI) navigation device 1514 (e.g., a mouse). In an example, the display device 1510, alphanumeric input device 1512, and UI navigation device 1514 may be a touch screen display. The machine 1500 may additionally include a mass storage device (e.g., drive unit) 1516, a signal generation device 1518 (e.g., a speaker), a network interface device 1520, and one or more sensors 1521, such as a Global Positioning System (GPS) sensor, compass, accelerometer, or another sensor. The machine 1500 may include an output controller 1528, such as a serial (e.g., universal serial bus (USB)), parallel, or other wired or wireless (e.g., infrared (IR), near field communication (NFC)) connection to communicate with or control one or more peripheral devices (e.g., a printer, card reader).

The mass storage device 1516 may include a machine-readable medium 1522 on which is stored one or more sets of data structures or instructions 1524 (e.g., software) embodying or utilized by any one or more of the techniques or functions described herein. The instructions 1524 may also reside, completely or at least partially, within the main memory 1504, within the static memory 1506, within the hardware processor 1502, or within the GPU 1503 during execution thereof by the machine 1500. In an example, one or any combination of the hardware processor 1502, the GPU 1503, the main memory 1504, the static memory 1506, or the mass storage device 1516 may constitute machine-readable media.

While the machine-readable medium 1522 is illustrated as a single medium, the term “machine-readable medium” may include a single medium, or multiple media, (e.g., a centralized or distributed database, and/or associated caches and servers) configured to store the one or more instructions 1524.

The term “machine-readable medium” may include any medium that is capable of storing, encoding, or carrying instructions 1524 for execution by the machine 1500 and that cause the machine 1500 to perform any one or more of the techniques of the present disclosure, or that is capable of storing, encoding, or carrying data structures used by or associated with such instructions 1524. Non-limiting machine-readable medium examples may include solid-state memories, and optical and magnetic media. In an example, a massed machine-readable medium comprises a machine-readable medium 1522 with a plurality of particles having invariant (e.g., rest) mass. Accordingly, massed machine-readable media are not transitory propagating signals. Specific examples of massed machine-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 1524 may further be transmitted or received over a communications network 1526 using a transmission medium via the network interface device 1520.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Additionally, as used in this disclosure, phrases of the form “at least one of an A, a B, or a C,” “at least one of A, B, and C,” and the like, should be interpreted to select at least one from the group that comprises “A, B, and C.” Unless explicitly stated otherwise in connection with a particular instance, in this disclosure, this manner of phrasing does not mean “at least one of A, at least one of B, and at least one of C.” As used in this disclosure, the example “at least one of an A, a B, or a C,” would cover any of the following selections: {A}, {B}, {C}, {A, B}, {A, C}, {B, C}, and {A, B, C}.

Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A computer-implemented method comprising:
generating a user interface (UI) for identifying a baseline segment and a target segment of users of a product or service;
providing, in the UI, at least one option for configuring parameters for generating a hypothesis;
generating the hypothesis based on the configured parameters, the hypothesis defining a campaign to reach members of the baseline segment in order to transfer members from the baseline segment to the target segment;
estimating, by a machine-learning (ML) model, at least one performance metric value that would result from implementing the hypothesis to transfer members from the baseline segment to the target segment; and
causing presentation on the UI of the hypothesis and the at least one performance metric.

2. The method as recited in claim 1, wherein the ML model receives as input information about a user and information about the hypothesis, wherein the ML model provides an output that is a retention rate of the user during a predetermined period.

3. The method as recited in claim 1, wherein generating the hypothesis further comprises:
identifying a plurality of hypotheses based on a plurality of features of an application, each hypothesis identifying a transition from a potential baseline segment to a potential target segment based on values of the features assigned to the potential baseline segment and the potential target segment.

4. The method as recited in claim 3, further comprising:
determining, for a plurality of combinations of baseline segment and target segment, a value of a performance improvement for transferring users from the potential baseline segment to the potential target segment; and
ranking the plurality of combinations based on the value of the performance improvement.

5. The method as recited in claim 1, wherein the ML model is trained with training data comprising values for at least one feature from a plurality of features, the plurality of features comprising total number of actions, compose, months since subscription start, consume, publish, command diversity, premium designer, record, design, format, reuse, illustrate, review, editor grammar, rehearse, animate, auto alt text, share, premium editor style, or draw.

6. The method as recited in claim 5, further comprising:
causing presentation on a feature UI of the features and a corresponding value for a feature importance for improving the performance metric.

7. The method as recited in claim 1, further comprising:
obtaining usage data from a plurality of users of the product or service; and
clustering, by an unsupervised ML model, the plurality of users into two or more clusters of users.

8. The method as recited in claim 7, wherein information for each cluster comprises a size of the cluster, a usage rate of the product or service, a retention rate for the cluster, and activities associated with the cluster.

9. The method as recited in claim 1, wherein the product is a software application used by the users, wherein features associated with the ML model include values regarding how the users utilize multiple features of the software application.

10. The method as recited in claim 1, further comprising:
causing presentation of a hypothesis-factory UI to present information on the baseline segment, the target segment and a difference in performance between the baseline segment and the target segment.

11. A system comprising:
a memory comprising instructions; and
one or more computer processors, wherein the instructions, when executed by the one or more computer processors, cause the system to perform operations comprising:
generating a user interface (UI) for identifying a baseline segment and a target segment of users of a product or service;
providing, in the UI, at least one option for configuring parameters for generating a hypothesis;
generating the hypothesis based on the configured parameters, the hypothesis defining a campaign to reach members of the baseline segment in order to transfer members from the baseline segment to the target segment;
estimating, by a machine-learning (ML) model, at least one performance metric value that would result from implementing the hypothesis to transfer members from the baseline segment to the target segment; and
causing presentation on the UI of the hypothesis and the at least one performance metric.

12. The system as recited in claim 11, wherein the ML model receives as input information about a user and information about the hypothesis, wherein the ML model provides an output that is a retention rate of the user during a predetermined period.

13. The system as recited in claim 11, wherein generating the hypothesis further comprises:
identifying a plurality of hypotheses based on a plurality of features of an application, each hypothesis identifying a transition from a potential baseline segment to a potential target segment based on values of the features assigned to the potential baseline segment and the potential target segment.

14. The system as recited in claim 13, wherein the instructions further cause the one or more computer processors to perform operations comprising:
determining, for a plurality of combinations of baseline segment and target segment, a value of a performance improvement for transferring users from the potential baseline segment to the potential target segment; and
ranking the plurality of combinations based on the value of the performance improvement.

15. The system as recited in claim 11, wherein the ML model is trained with training data comprising values for at least one feature from a plurality of features, the plurality of features comprising total number of actions, compose, months since subscription start, consume, publish, command diversity, premium designer, record, design, format, reuse, illustrate, review, editor grammar, rehearse, animate, auto alt text, share, premium editor style, or draw.

16. A tangible machine-readable storage medium including instructions that, when executed by a machine, cause the machine to perform operations comprising:
generating a user interface (UI) for identifying a baseline segment and a target segment of users of a product or service;
providing, in the UI, at least one option for configuring parameters for generating a hypothesis;
generating the hypothesis based on the configured parameters, the hypothesis defining a campaign to reach members of the baseline segment in order to transfer members from the baseline segment to the target segment;
estimating, by a machine-learning (ML) model, at least one performance metric value that would result from implementing the hypothesis to transfer members from the baseline segment to the target segment; and
causing presentation on the UI of the hypothesis and the at least one performance metric.

17. The tangible machine-readable storage medium as recited in claim 16, wherein the ML model receives as input information about a user and information about the hypothesis, wherein the ML model provides an output that is a retention rate of the user during a predetermined period.

18. The tangible machine-readable storage medium as recited in claim 16, wherein generating the hypothesis further comprises:
identifying a plurality of hypotheses based on a plurality of features of an application, each hypothesis identifying a transition from a potential baseline segment to a potential target segment based on values of the features assigned to the potential baseline segment and the potential target segment.

19. The tangible machine-readable storage medium as recited in claim 18, wherein the machine further performs operations comprising:
determining, for a plurality of combinations of baseline segment and target segment, a value of a performance improvement for transferring users from the potential baseline segment to the potential target segment; and
ranking the plurality of combinations based on the value of the performance improvement.

20. The tangible machine-readable storage medium as recited in claim 16, wherein the ML model is trained with training data comprising values for at least one feature from a plurality of features, the plurality of features comprising total number of actions, compose, months since subscription start, consume, publish, command diversity, premium designer, record, design, format, reuse, illustrate, review, editor grammar, rehearse, animate, auto alt text, share, premium editor style, or draw.
